(19) United States
(12) Patent Application Publication
(10) Pub. No.: US 2004/0107786 A1
(43) Pub. Date: Jun. 10, 2004

(54) Gearbox with intermeshing gears mounted on one shaft

(76) Inventors: Alan Mawson, Manchester (GB); David Taylor, Lancashire (GB); Derek Corns, Manchester (GB); Giovanni Hawkins, London (GB)

Correspondence Address: RADER, FISHMAN & GRAUER PLLC, 39533 WOODWARD AVENUE, SUITE 140, BLOOMFIELD HILLS, MI, 48304-0610, US

(21) Appl. No.: 10/250,624

(22) PCT Filed: Jan. 3, 2002
(86) PCT No.: PCT/GB02/00008

(30) Foreign Application Priority Data
Jan. 4, 2001 (GB) 0100145.2
Apr. 23, 2001 (GB) 0109832.6

(51) Int. Cl. F16H 3/08

(52) U.S. Cl. 74/329

(57) ABSTRACT

A gear box 1 has an input shaft 2, an output shaft 4 and a counter-shaft 6. A headcut gear 8 mounted on the input shaft 2 intermeshes with a first counter-shaft 10 mounted on the counter-shaft 6. A second counter-shaft gear 12, intermeshes with a corresponding gear 16, mounted on the output shaft 4. The first two counter-shaft gears 10, 12 are interlocked by virtue of inter-engaging means comprising, for instance, a protrusion 24 from one of the two gears and a protrusion receiving recess 30 in the other of the two gears 10,12. Interlocking the two gears 10,12 prevents one rotating relative to the other in the event, say, of a torque spike.

The invention relates to gear boxes, that is, an arrangement of gears mounted on shafts for converting the drive from an engine into usable power, and in particular to vehicle gear boxes.

The gear box of a vehicle typically comprises an input shaft from an engine and an output shaft to an axle. Engine drive may be engaged and disengaged from the input shaft using a clutch. The input and output shafts may be concentrically aligned and alongside them, in spaced apart parallel relationship, may be a further shaft known commonly as counter shaft or layshaft. Mounted on the input shaft may be a gear which forms part of the so-called headset. The headset gear may mesh with one of a line of gears on the counter shaft. The remainder of the counter shaft gears (another four, for example) may mesh with corresponding gears of a line on the output shaft. Each counter shaft gear and its corresponding output shaft gear provides a different gearing ratio. The drive delivery train from the input shaft to the output shaft is sequentially via the headset gear, the counter shaft gears and the output shaft gears.

Some vehicle gear boxes, particularly those for heavy duty use, for example in trucks, have multiple counter shafts. By transmitting the drive from input shaft to output shaft via, for instance, pairs of counter shaft gears, each mounted on one of two opposed counter shafts, the overall load and therefore stress on each counter shaft gear may be reduced significantly.

Most commonly, the output shaft gears are provided with some form of clutch mechanism by which they may be engaged or disengaged from the output shaft. Exactly which gear is engaged, and thus the input:output drive ratio, may be determined by a gear selection mechanism. In such an arrangement, the counter shaft gears may be made fast with the counter shaft. Alternatively, the counter shaft gears may be selectively engageable with the counter shaft in which case the output shaft gears may be fast with the output shaft.

Gears may be formed by, say, machining or forging. Two or more gears intended for adjacent location on a shaft may be formed together. The forging of adjacent gears is limited by size. Hence, gears are most commonly formed individually.

A gear may be made fast with its respective shaft by, for instance, interference or press fitting or by keying or pinning it on to the shaft. Interference fitting is, for the most part, a wholly adequate manner of making fast. However, its limitation is its possible behaviour in the event of a so-called torque spike.

Torque spikes may be caused by aggressive gear selection which may result in a sudden and abrupt introduction of input drive. Accordingly, an interference fit gear may have applied to it a force which exceeds the frictional restraint of the fit. As a consequence, the gear may slip and no longer rotate with its respective shaft. This may result in loss of drive to the axle which could have safety implications: for example, loss of drive for a truck tackling a steep incline could have potentially dangerous consequences. Also, a gear may be dislocated which could contribute to a shortened usable lifetime.

The invention provides a gear box comprising at least one shaft and at least two gears mounted on the or each shaft wherein two adjacent gears of the at least two gears have inter-engaging means. The inter-engaging means restricts one of the two adjacent gears from revolving relative to the other one. In effect, the two adjacent gears are interlocked. In the event that the output shaft gears are disengageable from the output shaft and the counter shaft gears are made fast with the counter shaft, it is adjacent counter shaft gears that will have need for the inter-engaging means. The gear box may have multiple counter shafts and adjacent gears on each of the counter shafts may have a need for the inter-engaging means. In the event that the counter shaft gears are disengageable from the counter shaft and the output shaft gears are made fast with the output shaft, it is adjacent output shaft gears that will have need for the inter-engaging means.

The inter-engaging means may comprise at least one protrusion from one of the two adjacent gears and a protrusion receiving recess in the other of the two adjacent gears. Preferably, the protrusion is of a blunted saw tooth shape and the recess is correspondingly shaped. However, the protrusion may be square, rectangular, arcuate, saw tooth shaped, involute, cycloid or any shape which, in combination with the corresponding shape of recess, enables the two gears to inter-engage. Further preferably, each of the two adjacent gears has an abutment surface, which is the axially end surface with which that gear abuts the adjacent gear, and the protrusion extends from the abutment surface of one of the gears and the protrusion receiving recess is in the abutment surface of the other gear. Also further preferably, the junction between the abutment surface and the protrusion is radiused. Such radiusing reduces stress concentrations on the gear. The junction may be cut into the abutment surface, again to reduce stress concentrations.

Alternatively, the inter-engaging means may comprise means for fastening the two adjacent gears together. The means for fastening may comprise means for bolting, screwing, gluing or welding the two adjacent gears together.

In the event that two adjacent counter shaft gears are provided with the inter-engaging means, one of the two adjacent gears may intermesh with a gear on the input shaft and the other may intermesh with a gear on the output shaft. On the other hand, both of the two adjacent gears may intermesh with corresponding gears on the output shaft.

At least one of the two adjacent gears may be interference or press fitted on to its respective shaft.

More than two adjacent gears may have inter-engaging means.

The invention further provides a gear box comprising a shaft, at least two gears mounted on the shaft and means for interlocking two adjacent gears of the at least two gears such that one of the two adjacent gears is restricted from revolving relative to the other one. At least one of the two gears may be press or interference fitted on to its respective shaft.

The invention also further provides a method of making a gear box comprising providing a shaft, mounting a first gear on to the shaft and mounting a second gear on to the shaft in inter-engagement with the first. The first and second gears may be mounted such that a protrusion on the first gear is received in a recess on the second gear. At least one of the first and second gears may be press or interference fitted on to the shaft.

The invention additionally further provides a method of making two gears for mounting adjacently on a shaft of a gear box comprising forming each gear such that when mounted on the shaft the two gears inter-engage. Preferably, the forming is by forging, which is advantageous because it provides a relatively stronger finished product in comparison to machining. It is also a less costly method of forming. Further preferably, one of the gears may be formed with a protrusion and the other may be formed with a protrusion receiving recess. In the event that the gears are formed by forging, the protrusion may be of a shape which facilitates removal of the gear from the forge mould. Each gear may be finished after forging.

The invention will now be described, by way of example, with reference to the following drawings, in which:

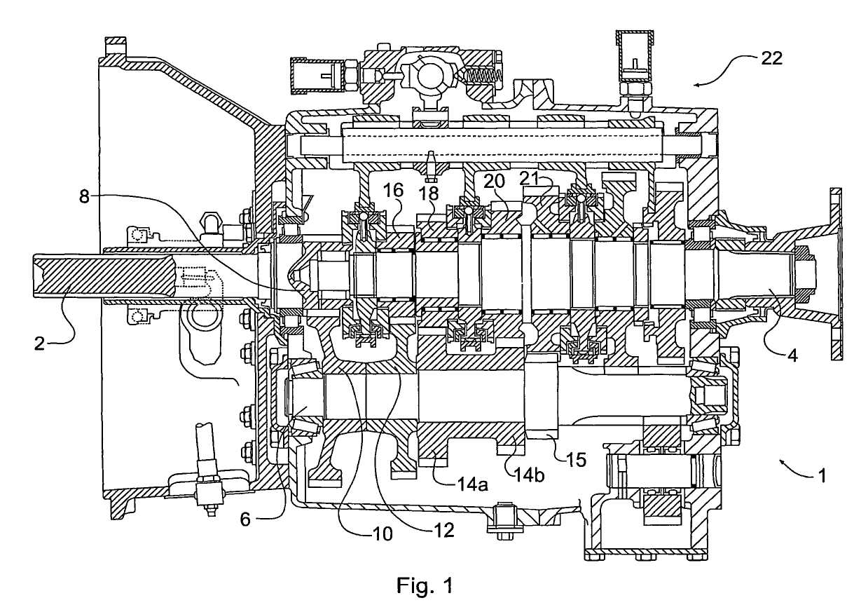

FIG. 1 is a side cross sectional view of a single counter shaft vehicle gear box according to one aspect of the invention; and

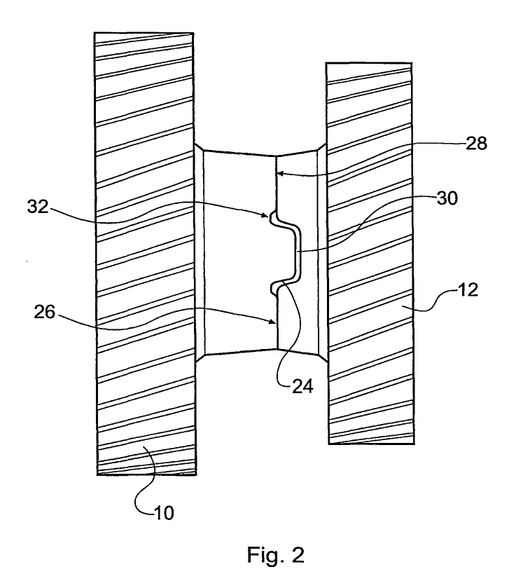

FIG. 2 is a side view of two adjacent counter shaft gears as utilised in the gear box shown in FIG. 1.

With reference to FIG. 1, a truck gear box indicated generally at 1 has an input shaft 2 and, concentrically aligned with the input shaft 2, an output shaft 4. In parallel relationship with the concentric, rotational axis of the input and output shafts 2, 4, and spaced apart from them, is a counter shaft 6. Mounted at the end of the input shaft 2 is a headset gear 8. This intermeshes with a first counter shaft gear 10 mounted on the left hand end of the counter shaft 6 as viewed in the figure. The input 2 is connected to an engine (not shown) through a clutch (not shown). The output shaft 4 is connected, indirectly, to an axle (not shown).

Mounted adjacent (to the right as viewed in the figure) the first counter shaft gear 10 is a second counter shaft gear 12 and next to that are third and fourth counter shaft gears 14a, 14b. Thus, the four counter shaft gears 10, 12, 14a and 14b are mounted in a line with the first adjacent the second 12 and the second 12 adjacent the third 14a. The third and fourth gears 14a, 14b are formed together as one piece. Each of the first and second and the third and fourth counter shaft gears 10, 12, 14a, 14b is press fitted on to the counter shaft 6 and is retained in position by friction. Adjacent the third and fourth gears 14a, 14b is a fifth gear 15 which is formed as part of the counter shaft 6. Each of the second, third, fourth and fifth counter shaft gears 12, 14a, 14b, 15 intermeshes with a corresponding gear 16, 18, 20, 21 each mounted on the output shaft 4 respectively. A gear selection device indicated generally at 22 determines which of the output shaft gears 16, 18, 20, 21 is locked on to the output shaft 4, and thus drive is delivered via the headset gear 8, the first counter shaft 10 gear, and the counter shaft gear 12, 14a, 14b, 15 corresponding to whichever of the output shaft gears 16, 18, 20, 21 has been selected. Each counter shaft gear 12, 14a, 14b, 15 output shaft gear 16, 18, 20, 21 combination provides a different gearing ratio. The ratio of the input drive to the output drive is consequently determined by the gear selection.

With reference also to FIG. 2, the first counter shaft gear 10 has an axially end abutment face 26 which abuts with the axially end abutment face 28 of the second counter shaft gear 12. The first counter shaft gear 10 has a protrusion 24 extending from its abutment face 26 in the direction of the adjacent gear 12. Within the abutment face 28 of the second gear 12 is a protrusion receiving recess 30 which is generally of complimentary shape to the protrusion 24. The protrusion 24 is what is termed a blunted saw tooth shape in that, when viewed from the side (as in FIG. 2) it appears to have the shape of a saw tooth whose tip has been blunted.

By virtue of the protrusion 24 extending into the recess 30, the first and second gears 10, 12 inter-engage. Effectively, they are interlocked. This has the effect of preventing one of the first and second counter shaft gears, 10, 12 revolving about the counter shaft 6 relative to the other. Hence, in the event, say, of a torque spike in the drive on the input shaft 2, which may be such as to exceed the frictional restraint on one of the first and second gears 10, 12 the inter-engagement of the two gears has the effect of opposing any such tendency. The interlocking of the first and second gears 10, 12 results in the combined frictional restraint of each gear being offered to oppose any torque spike.

Each of the first and second counter shaft gears 10, 12 is formed by forging. The shape for the protrusion 24 and consequently the recess 30 are chosen for ease of removal from the forge mould (not shown). In particular, by having the saw tooth, inclined edge type shape makes for ease of removal from the mould. In addition, the junction 32 between the protrusion and the abutment face 26 of the first gear 10 is radiused, that is to say, forged with a large radius in the region of the junction 32, so as to reduce stress concentration in use. Also, to assist with the reduction of stress concentration the radiusing at the junction 32 cuts into the abutment surface 26 following forging, the abutment surfaces 26, 28 of the first and second gears 10, 12 respectively are machined so as to provide plain surfaces.

1. A gear box comprising at least one shaft and at least two gears mounted on the or each shaft wherein two adjacent gears of the at least two gears have inter-engaging means.

2. A gear box according to claim 1 wherein the or each shaft is a counter shaft and the at least two gears are counter shaft gears made fast with the counter shaft.

3. A gear box according to claim 1 wherein the or each shaft is an output shaft and the at least two gears are output shaft gears made fast with the output shaft.

4. A gear box according to any of claims 1 to 3 wherein the inter-engaging means comprises at least one protrusion from the one of the two adjacent gears and a protrusion receiving recess in the other of the two adjacent gears.

5. A gear box according to claim 4 wherein the protrusion is of blunted saw tooth shape, saw tooth shape, square, rectangular, arcuate, involute or cycloid and the recess is correspondingly shaped.

6. A gear box according to claim 4 or claim 5 wherein each of the two adjacent gears has an abutment surface, which is the axially end surface with which that gear abuts the adjacent gear, and the protrusion extends from the abutment surface of one of the gears and the protrusion receiving recess is in the abutment surface of the other gear.

7. A gear box according to claim 6 wherein the junction between the abutment surface and the protrusion is radiused.

8. A gear box according to claim 6 or claim 7 wherein the junction is cut into the abutment surface.

9. A gear box according to any of claims 1 to 3 wherein the inter-engaging means comprises means for fastening the two adjacent gears together.

10. A gear box according to claim 9 wherein the means for fastening comprises means for bolting, screwing, gluing or welding the two adjacent gears together.

11. A gear box according to claim 2 further comprising an input shaft and an output shaft, and one of the two adjacent gears intermeshes with a gear on the input shaft and the other of the two adjacent gears intermeshes with a gear on the output shaft.

12. A gear box according to claim 2 further comprising an output shaft wherein both of the two adjacent gears intermesh with corresponding gears on the output shaft.

13. A gear box according to any of claims 1 to 12 wherein at least one of the two adjacent gears is mounted by interference or press fitting.

14. A gear box according to any of claims 1 to 13 comprising more than two adjacent gears having inter-engaging means.

15. A gear box comprising a shaft, at least two gears mounted on the shaft and means for interlocking two adjacent gears of the at least two gears such that one of the two adjacent gears is restricted from revolving relative to the other gear.

16. A method of making a gear box comprising providing a shaft, mounting a first gear on to the shaft and mounting a second gear on to the shaft in inter-engagement with the first gear.

17. A method according to claim 16 wherein the first and second gears are mounted such that a protrusion on the first gear is received in a recess on the second gear.

18. A method of making two gears for mounting adjacently on a shaft of a gear box comprising forming each gear such that when mounted on the shaft the two gears inter-engage.

19. A method according to claim 18 wherein the forming is by forging.

20. A method according to claim 19 wherein one of the gears is formed with a protrusion and the other gear is formed with a protrusion receiving recess, and the protrusion may be of a shape which facilitates removal of the gear from a forge mould.
